(19) United States
(12) Patent Application Publication
(10) Pub. No.: US 2025/0212250 A1
(43) Pub. Date: Jun. 26, 2025

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Wei LUO, Shenzhen (CN); Lin CHEN, Shenzhen (CN); Weiqiang DU, Shenzhen (CN)

(73) Assignee: ZTE CORPORATION, Shenzhen (CN)

(21) Appl. No.: 18/985,262

(22) Filed: Dec. 18, 2024

Related U.S. Application Data
(63) Continuation of application No. PCT/CN2023/076519, filed on Feb. 16, 2023.

(51) Int. Cl. H04W 74/0808; H04W 92/18

(52) U.S. Cl. CPC H04W 74/0808; H04W 92/18

(57) ABSTRACT

A wireless communication method is disclosed. The method comprises performing, by a first wireless communication terminal, a detection for a consistent listen-before-talk, LBT, failure of a sidelink transmission on one or more sidelink resource sets; and performing, by the first wireless communication terminal, at least one of the following operations in response to the consistent LBT failure of the sidelink transmission being detected on a first sidelink resource set of the one or more sidelink resource sets: setting the first sidelink resource set as an unavailable sidelink resource set, and then setting the first sidelink resource set as an available sidelink resource set in response to one or more predetermined conditions being met; or transmitting, to a second wireless communication terminal, a consistent LBT failure indication via a second sidelink resource set.

### CROSS-REFERENCE TO RELATED PATENT APPLICATIONS

This application is a Continuation of PCT Application No. PCT/CN2023/076519, filed Feb. 16, 2023, incorporated herein by reference in its entirety.

### TECHNICAL FIELD

This document is directed to methods, systems, and devices related to wireless communication, in particular to 5^{th} generation wireless communication(s), and more specifically, to provide sidelink communication solutions when performing sidelink communication on an unlicensed carrier (shared spectrum).

### BACKGROUND

Wireless communications are often performed with user terminal devices and base stations. In addition, wireless communication is performed on carriers or frequency bands. Some carriers are licensed carriers, which are carriers licensed by a governmental or other authoritative entity to a service provider for exclusive use. Other carriers are unlicensed carriers, which are carriers not licensed by such governmental or other authoritative entities. Currently, user terminal devices communicate directly with each other (i.e., without use of a base station) on licensed carriers. However, ways for user terminal devices to communicate directly with each other on unlicensed carriers may be desirable.

### SUMMARY

This document relates to methods, systems, and devices for sidelink communication.

One aspect of the present disclosure relates to a wireless communication method. In an embodiment, the wireless communication method includes: performing, by a first wireless communication terminal, a detection for a consistent listen-before-talk, LBT, failure of a sidelink transmission on one or more sidelink resource sets; and performing, by the first wireless communication terminal, at least one of the following operations in response to the consistent LBT failure of the sidelink transmission being detected on a first sidelink resource set of the one or more sidelink resource sets: setting the first sidelink resource set as an unavailable sidelink resource set, and then setting the first sidelink resource set as an available sidelink resource set in response to one or more predetermined conditions being met; or transmitting, to a second wireless communication terminal, a consistent LBT failure indication via a second sidelink resource set.

Another aspect of the present disclosure relates to a wireless communication method. In an embodiment, the wireless communication method includes: performing, by a first wireless communication terminal, a detection for a consistent listen-before-talk, LBT, failure of a sidelink transmission on multiple sidelink resource sets.

Another aspect of the present disclosure relates to a wireless communication method. In an embodiment, the wireless communication method includes: performing, by a first wireless communication terminal, a detection (e.g., for a consistent listen-before-talk, LBT, failure) of a sidelink transmission on one or more sidelink resource sets; and suspending at least one of following for a link associated to the first sidelink resource set: a sidelink consecutive Discontinuous Transmission, DTX, counter, a radio resource control, RRC, reconfiguration related timer, a Radio Link Control, RLC, service data unit, SDU, for a retransmission, or a RETX_COUNT.

Another aspect of the present disclosure relates to a wireless communication method. In an embodiment, the wireless communication method includes: receiving, by a second wireless communication terminal from a first wireless communication terminal, a first consistent listen-before-talk, LBT, failure indication; and performing, by the second wireless communication terminal, at least one of the following operations in response to the consistent LBT failure being received: transmitting, to a wireless communication node, a second consistent LBT failure; or selecting a second sidelink resource set for a sidelink communication.

Various embodiments may preferably implement the following features:

Preferably or in some embodiments, the sidelink resource set comprises at least one of: a sidelink resource pool, a sidelink resource block, RB, set, a frequency resource range, or a sidelink bandwidth part, BWP.

Preferably or in some embodiments, the one or more predetermined conditions comprises at least one of:
an expiration of a timer started in response to an LBT failure indication from an LBT procedure on the first sidelink resource set or a sidelink consistent LBT failure triggered according to an LBT procedure on the first sidelink resource set;
a result of an LBT procedure on the first sidelink resource set being a success; or a channel occupancy rate on the first sidelink resource set being lower than a first predetermined threshold.

Preferably or in some embodiments, the one or more predetermined conditions comprises at least one of:
the first wireless communication terminal receiving sidelink data or signaling from a user device in the first sidelink resource set;
a channel busy ratio being lower than a second predetermined threshold in the first sidelink resource set; or
a Received Signal Strength Indicator, RSSI, being lower than a third predetermined threshold in the first sidelink resource set.

Preferably or in some embodiments, the first wireless communication terminal receives from a wireless communication node at least one of: a timer value for the timer, a value for the first predetermined threshold, a value for the second predetermined threshold, or a value for the third predetermined threshold.

Preferably or in some embodiments, the first wireless communication terminal performs the sidelink transmission via an exception sidelink resource set in response to all configured normal transmission sidelink resource sets are unavailable.

Preferably or in some embodiments, the consistent LBT failure indication comprises an identifier of the first sidelink resource set.

Preferably or in some embodiments, the first wireless communication terminal transmits sidelink resource set configuration information which includes frequency resources information associated to each identifier of sidelink resource set.

Preferably or in some embodiments, the first wireless communication terminal transmits to a second wireless communication terminal, a consistent LBT failure recovery indication in response to the first sidelink resource set becomes available.

Preferably or in some embodiments, the first wireless communication terminal suspends a sidelink consecutive Discontinuous Transmission, DTX, counter, a radio resource control, RRC, a reconfiguration related timer, a Radio Link Control, RLC, service data unit, SDU, for a retransmission, or a RETX_COUNT for a link associated to the first sidelink resource set.

Preferably or in some embodiments, the sidelink consecutive DTX counter, the RRC reconfiguration related timer, the RLC SDU for the retransmission or the RETX_COUNT is suspended in response to at least one of:
an LBT failure on the first sidelink resource set being detected;
a channel busy ratio being higher than a second predetermined threshold in the first sidelink resource set;
an RSSI being higher than a third predetermined threshold in the first sidelink resource set; or
a LBT failure rate on the first sidelink resource set being higher than a fourth predetermined threshold.

Preferably or in some embodiments, a suspension of the sidelink consecutive DTX counter, the RRC reconfiguration related timer, the RLC SDU for the retransmission or the RETX_COUNT is canceled in response to at least one of:
the first wireless communication terminal receiving sidelink data or signaling from a user device in the first sidelink resource set;
a channel busy ratio being lower than a second predetermined threshold in the first sidelink resource set;
an RSSI being lower than a third predetermined threshold in the first sidelink resource set;
a result of an LBT procedure on the first sidelink resource set being a success;
a LBT failure rate on the first sidelink resource set being lower than a fourth predetermined threshold; or
the first sidelink resource set that becomes to an available sidelink resource set.

Preferably or in some embodiments, in response to a first sidelink resource set of the multiple sidelink resource sets having a LBT failure, the first wireless communication terminal starts or restarts a timer associated to the first sidelink resource set, increments a counter associated to the first sidelink resource set, and determines whether a consistent LBT failure occurs on the first sidelink resource set according to a counter value of the counter.

Preferably or in some embodiments, the at least one of the sidelink consecutive DTX counter, the RRC reconfiguration related timer, the RLC SDU for the retransmission, or the RETX_COUNT is suspended in response to at least one of:
an LBT failure on the first sidelink resource set being detected;
a channel busy ratio being higher than a second predetermined threshold in the first sidelink resource set;
an RSSI being higher than a third predetermined threshold in the first sidelink resource set; or
a LBT failure rate on the first sidelink resource set being higher than a fourth predetermined threshold.

Preferably or in some embodiments, a suspension of the at least one of the sidelink consecutive DTX counter, the RRC reconfiguration related timer, the RLC SDU for the retransmission, or the RETX_COUNT is canceled in response to at least one of:
the first wireless communication terminal receiving sidelink data or signaling from a user device in the first sidelink resource set;
a channel busy ratio being lower than a second predetermined threshold in the first sidelink resource set;
an RSSI being lower than a third predetermined threshold in the first sidelink resource set;
a result of an LBT procedure on the first sidelink resource set being a success;
a LBT failure rate on the first sidelink resource set being lower than a fourth predetermined threshold; or
the first sidelink resource set that becomes to an available sidelink resource set.

Preferably or in some embodiments, the first wireless communication terminal performs at least one of the following operations:
instructing, via a Medium Access Control, MAC layer module, a physical layer module to signal a negative acknowledgement on a physical uplink control channel, PUCCH, to a wireless communication node in response to a transmission of a MAC Protocol Data Unit, PDU, being performed and an LBT failure indication being received from the physical layer module;
stopping an sl-CSI-ReportTimer for a triggered sidelink channel status information, SL-CSI, reporting in response to a Sidelink CSI Reporting Medium Access Control Control Element, MAC CE, being sent and an LBT failure indication not being received from the physical layer module;
canceling a triggered SL-CSI reporting in response to a Sidelink CSI Reporting Medium Access Control Control Element, MAC CE, being sent and an LBT failure indication being not received from the physical layer module;
stopping an sl-IUC-ReportTimer for a triggered sidelink inter-UE coordination, SL-IUC, Information reporting in response to a Sidelink IUC MAC CE being sent and an LBT failure indication being not received from the physical layer module; or
canceling a triggered SL-IUC reporting in response to a Sidelink IUC MAC CE being sent and an LBT failure indication being not received from the physical layer module.

Preferably or in some embodiments, the second consistent LBT failure indication comprises at least one of a sidelink resource set indication or a destination identity, and the destination identity indicates the first wireless communication terminal which detects the consistent LBT failure.

Preferably or in some embodiments, the sidelink resource set indication comprises at least one of: a non-preferred sidelink resource set, a preferred sidelink resource set, an available sidelink resource set or an unavailable sidelink resource set.

Preferably or in some embodiments, the second wireless communication terminal performs at least one of:
selecting a resource pool for the sidelink transmission among available resource pools, wherein the available resource pools exclude an unavailable resource pool indicated by the consistent LBT failure indication;
selecting time and frequency resources for the sidelink transmission among available channels or resource block, RB, sets, wherein the available channels or RB sets exclude an unavailable channel or RB set indicated by the consistent LBT failure indication; or
indicating, via a Medium Access Control, MAC layer module to a physical layer module, an unavailable or non-preferred channel or RB set according to the consistent LBT failure indication.

Preferably or in some embodiments, the second wireless communication terminal suspends a sidelink consecutive Discontinuous Transmission, DTX, counter, a radio resource control, RRC, reconfiguration related timer, an RLC SDU for a retransmission or RETX_COUNT for a link associated to the first sidelink resource set in response to the consistent LBT failure indication being received.

Preferably or in some embodiments, a suspension of the sidelink consecutive DTX counter, the RRC reconfiguration related timer, the RLC SDU for the retransmission or the RETX_COUNT is canceled in response to at least one of:
the second wireless communication terminal receiving sidelink data or signaling from a user device in the first sidelink resource set;
the second wireless communication terminal receiving sidelink data or signaling from the first wireless communication terminal;
the second wireless communication terminal determining that the first sidelink resource set has become available;
the second wireless communication terminal receiving a consistent LBT failure recovery indication; or
the second wireless communication terminal determining to cancel the suspension of the sidelink consecutive DTX counter, the RRC reconfiguration related timer, the RLC SDU for the retransmission, or the RETX_COUNT.

The present disclosure relates to a wireless communication terminal including a communication unit and a processor. The processor is configured to implement a wireless communication method recited in any one of foregoing methods.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

In some implementations, a device, such as a network device, is disclosed. The device may include one or more processors and one or more memories, wherein the one or more processors are configured to read computer code from the one or more memories to implement any one of the methods above.

In some implementations, a computer program product is disclosed. The computer program product may include a non-transitory computer-readable program medium with computer code stored thereupon, the computer code, when executed by one or more processors, causing the one or more processors to implement any one of the methods above.

The above and other aspects and their implementations are described in greater detail in the drawings, the descriptions, and the claims.

### BRIEF DESCRIPTION OF THE DRAWINGS

FIG. 1 shows a block diagram of a wireless communication system according to an embodiment of the present disclosure.

FIG. 2 shows a block diagram of a configuration of layer entities for a communication node according to an embodiment of the present disclosure.

FIG. 3 shows an example of a schematic diagram of a wireless terminal according to an embodiment of the present disclosure.

FIG. 4 shows an example of a schematic diagram of a wireless network node according to an embodiment of the present disclosure.

FIGS. 5 to 8 show flowcharts of methods according to some embodiments of the present disclosure.

### DETAILED DESCRIPTION

The present description describes various embodiments of systems, apparatuses, devices, and methods for wireless communications involving sidelink transmissions, including those in unlicensed carriers.

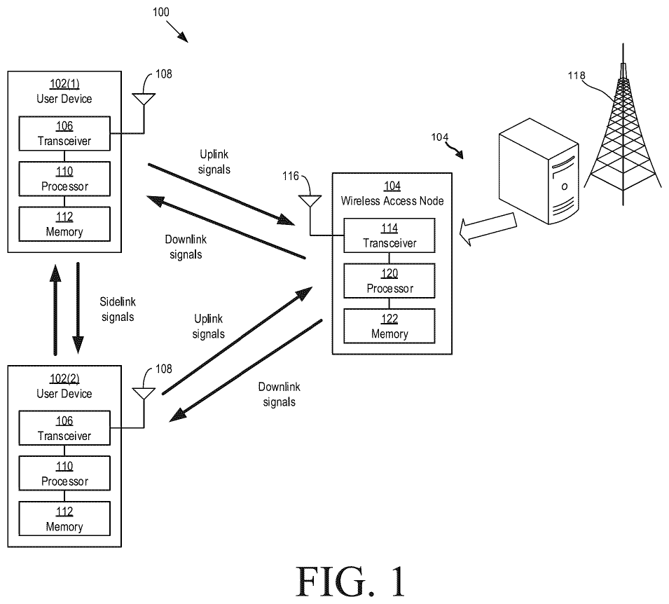

FIG. 1 shows a diagram of a wireless communication system 100 including a plurality of communication nodes (or just nodes) that are configured to wirelessly communicate with each other according to an embodiment. In an embodiment, the communication nodes may include at least one user device 102 and at least one wireless access node 104. The wireless communication system 100 in FIG. 1 is shown as including two user devices 102, including a first user device 102(1) and a second user device 102(2), and one wireless access nodes 104. However, various other examples of the wireless communication system 100 may be encompassed by the disclosure that include any of various combinations of user devices 102 and wireless access nodes 104, including two or more user devices 102 without any wireless access nodes 104, only one user device 102 and only one wireless access node 104, only one user device 102 and two or more wireless access nodes 104, two or more user devices 102 and one or more wireless access nodes 104, or two or more wireless access nodes 104 without any user devices 102.

In an embodiment, a user device as described herein, such as the user devices 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the wireless access node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

In an embodiment, a wireless access node as described herein, such as the wireless access node 104, may include a single electronic device or apparatus, or multiple (e.g., a network of) electronic devices or apparatuses, and may comprise one or more base stations or other wireless network access points capable of communicating wirelessly over a network with one or more user devices and/or with one or more other wireless access nodes 104. In an embodiment, the wireless access node 104 may comprise a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In an embodiment, two communication nodes in the wireless system 100—such as a user device 102 and a wireless access node 104, two user devices 102 without a wireless access node 104, or two wireless access nodes 104 without a user device 102—may be configured to wirelessly communicate with each other in or over a mobile network and/or a wireless access network according to one or more standards and/or specifications. In an embodiment, the standards and/or specifications may define the rules or procedures under which the communication nodes can wirelessly communicate, which may include those for communicating in millimeter (mm)-Wave bands, and/or with multi-antenna schemes and beamforming functions. In addition, or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

In various embodiments, two or more of the communication nodes in the wireless system 100, may be configured to communicate according to vehicle networking standards and/or specifications. As used herein, vehicle networking refers to a large-scale system for wireless communication and information exchange involving a vehicle, pedestrians, roadside equipment, and the internet in accordance with any of various communication protocols and data exchange standards. Vehicle networking communications may enhance vehicle performance with respect to driving safety, traffic efficiency, usability or user convenience features, or entertainment. Additionally, in any of various embodiments, vehicle networking communication may be categorized into three types: communication between vehicles (also called vehicle-to-vehicle (V2V)); communication between a vehicle and roadside equipment/network infrastructure (called vehicle-to-infrastructure/vehicle-to-network (V2I/V2N)); and communication between vehicles and pedestrians (called vehicle-to-pedestrian (V2P)). These types of communications are collectively referred to as vehicle-to-everything (V2X) communication. Communication nodes participating in V2X communicates may communicate with each other according to any of various V2X standards or specifications.

In an embodiment, in the wireless system 100, the communication nodes are configured to wirelessly communicate signals between each other. In an embodiment, a communication in the wireless system 100 between two communication nodes can be or include a transmission or a reception, and is generally both simultaneously, depending on the perspective of a particular node in the communication. In an embodiment, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered as a transmission for the first node and a reception for the second node. Of course, since communication nodes in a wireless system 100 can both send and receive signals, a single communication node may be both a transmitting/source node and a receiving/destination node simultaneously or switch between being a sending node and a receiving node.

Also, certain signals can be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to another wireless access node 104. Also, for sidelink transmissions, a first/source user device 102 directly transmits a sidelink signal to a second/destination user device 102 without any forwarding of the sidelink signal to a wireless access node 104.

In an embodiment involving V2X communication, user devices 102 may perform sidelink transmissions. Such sidelink communications in V2X may be referred to as a PC5-based V2X communication or V2X communication. Additionally, for sidelink communications in V2X, user devices 102 may communicate sidelink signals to each other using a PC5 interface, where PC5 refers to a reference point where a user device 102 communicates with another user device 102 over a direct channel.

As V2X technology advances, including in the automation industry, scenarios for V2X communications are being increasingly diversified and require higher performance. Examples of advanced V2X services include vehicle platooning, extended sensors, advanced driving (semi-automated driving and full-automated driving), and remote driving. Example performance requirements for these advanced V2X services may include: supporting data packets with a size of 50 to 12,000 bytes, a transmission rate of 2 to 50 messages per second, a maximum end-to-end delay of 3 to 500 milliseconds, a reliability of 90% to 99.999%, a date rate of 0.5 to 1,000 Megabytes per second (Mbps), or a transmission range of 50 to 1,000 meters, as non-limiting examples.

In an embodiment, communication nodes using NR radio access operating with shared spectrum channel access may be configured to operate in different modes, where primary cells (PCells), primary secondary cells (PSCells) or secondary cells (SCells) can be in the shared spectrum, and an SCell may or may not be configured with uplink transmissions. Further, in both channel access modes, the wireless access node 104 and the user device 102 may be configured to apply or perform listen-before-talk (LBT) procedures before performing a transmission on a cell configured with shared spectrum channel access.

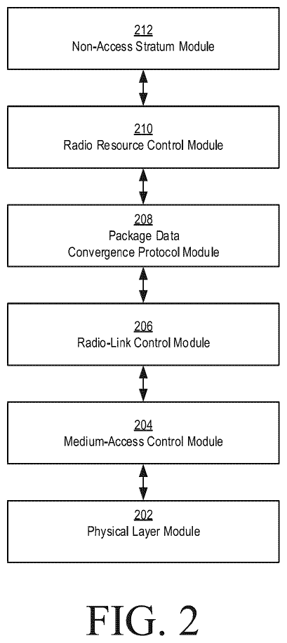

FIG. 2 shows a block diagram of a plurality of modules of a communication node (e.g., a user device 102 or a wireless access node 104), including a physical layer (PHY) entity or module (also called herein as just PHY layer, PHY module, or PHY entity) 202, a medium-access control (MAC) layer entity or module (also called herein as just MAC layer, MAC module, or MAC entity) 204, a radio-link control (RLC) layer entity or module (also called herein as just RLC layer, RLC entity, or RLC module) 206, a package data convergence protocol (PDCP) layer entity or module (also called herein as just PDCP layer, PDCP entity, or PDCP module) 208, a radio resource control (RRC) layer entity or module (also called herein as just RRC layer, RRC entity, or RRC module) 210, and a Non-Access Stratum (NAS) layer entity or module (also called herein as just NAS layer, NAS entity, or NAS module) 212.

In general, as used herein unless expressed otherwise, the terms “layer”, “entity”, and “module”, used alone or in combination with each other, and as used for one or more components of a communication node, is an electronic device, such as electronic circuit, that includes hardware or a combination of hardware and software. In various embodiments, a module or an entity may be considered part of, or a component of, or implemented using one or more of the components of a communication node of FIG. 1, including a processor 110/120, a memory 112/122, a transceiver circuit 106/114, or the antenna 108/116. For example, the processor 110/120, such as when executing computer code stored in the memory 112/116, may perform the functions of a module or entity. Additionally, in various embodiments, the functions that a module or entity performs may be defined by one or more standards or protocols, such as 5G NR for example.

Additionally, the layer entities 202-212 in FIG. 2 may be higher and lower layers relative to each other, with the PHY layer entity 202 being the lowest layer among the layer entities 202-212; the MAC layer entity 204 being a higher layer than the PHY layer entity 202 and lower than the other layer entities 206-212; the RLC layer entity 206 being higher than the PHY and MAC layer entities 202, 204 and lower than the PDCP, RRC, and NAS layer entities 208-212; the PDCP layer entity 208 being higher than the PHY, MAC, and RRC layer entities 202-206 and lower than the RRC and NAS layer entities 210, 212; the RRC layer entity 210 being higher than the PHY, MAC, RRC, and PDCP layer entities 202-208 and lower than the NAS layer entity 212; and the NAS layer entity 212 being the highest layer entity among the layer entities 202-220 shown in FIG. 2. In various embodiments, a communication node of the system 100 may include modules and/or layer entities other than those shown in FIG. 2.

### Embodiment 1

### LBT Detection for Each Sidelink Resource Set

In an embodiment, the first user device (also referred to as the first UE, the first wireless communication terminal or UE2 in this disclosure) may determine an LBT success or an LBT failure based on the LBT procedure, i.e., whether the LBT procedure results in an LBT success or an LBT failure. The first user device (e.g., a user equipment (UE)) may transmit the sidelink signal to a second user device (e.g., another UE) (also referred to as the second UE, the second wireless communication terminal or UE1 in this disclosure) in response to a LBT success; and may not transmit the sidelink signal in response to a LBT failure.

In an embodiment, the first user device may determine whether a sidelink consistent LBT failure is present according to the LBT procedure. In various embodiments, the first user device may determine a sidelink consistent LBT failure by counting LBT failures over several LBT procedures or iterations of an LBT procedure. In an embodiment, the user device may be configured with a sidelink maximum LBT failure count (SL-Ibt-FailureMaxCount) for sidelink consistent LBT failure detection, a sidelink failure detection timer (SL-Ibt-FailureDetectionTimer) for sidelink consistent LBT failure detection, and a sidelink LBT counter (SL-LBT_COUNTER) for LBT failures, which may initially be set to zero. In event that the first user device detects a LBT failure for an LBT procedure, the first user device may start or restart the sidelink failure detection timer. In addition, the first user device may increment the sidelink LBT counter by one. Subsequently, the first user device may compare a current value of the sidelink LBT counter with the sidelink maximum LBT failure count. If the current value is greater than or equal to sidelink maximum LBT failure count, then the first user device may detect a sidelink consistent LBT failure. In an embodiment, the first user device may use the sidelink failure detection timer with the counting. For example, the first user device may count during a time duration as measured by the sidelink failure detection timer. That is, the first user device may determine whether a sidelink consistent LBT failure has occurred based on the sidelink LBT counter counting during a time duration when the sidelink LBT failure detection timer is running (not expired). In response to the sidelink LBT failure detection timer expiring, or in the event that the sidelink LBT failure detection timer or the sidelink maximum LBT failure count is reconfigured by the MAC layer (or another upper layer), the user device may reset the sidelink LBT counter to zero or another initial value.

Also, in some embodiments, the PHY layer of the first user device may perform the LBT procedure, and/or determine whether the LBT procedure is a success or failure. If the PHY layer determines a LBT failure, then the PHY layer may send a sidelink failure indication to the MAC layer that indicates the LBT failure detected by the PHY layer. Also, the MAC layer may be configured with the sidelink maximum LBT failure count, the sidelink failure detection timer, and the sidelink LBT counter, and determine or detect sidelink consistent LBT failures in response to receipt of sidelink failure indications, as previously described.

However, the granularity of (consistent) sidelink LBT failure may be either SL (sidelink) resource pool or SL RB (resource block) set, and the first user device may be allowed to perform sidelink transmission on more than one resource pools or SL RB sets. In an embodiment, the first user device is configured with the following parameters in the lbt-FailureRecoveryConfig:
Ibt-FailureInstanceMaxCount for the consistent LBT failure detection; and
Ibt-FailureDetectionTimer for the consistent LBT failure detection;
and the UE may maintain one lbt-FailureDetectionTimer and one LBT_COUNTER for each sidelink resource set.

In an embodiment, the first user device may perform sidelink transmission on three sidelink resource sets, including resource set 1, resource set 2 and resource set 3. In an embodiment, the UE may maintain three lbt-FailureDetectionTimer and three LBT_COUNTER.

For each resource set x (x can be 1, 2 or 3) of the first user device, if LBT failure indication associated to resource set x has been received from lower layers, the first user device starts or restarts the Ibt-FailureDetectionTimer associated to resource set x, increments the LBT_COUNTER associated to resource set x by 1, and determining whether the LBT_COUNTER is larger than or equal to the lbt-FailureInstanceMaxCount. If so, the first user device triggers the consistent LBT failure for the resource set x. In some embodiments, if the lbt-FailureDetectionTimer associated to resource set x expires; or if the lbt-FailureDetectionTimer or the lbt-FailureInstanceMaxCount associated to resource set x is reconfigured by upper layers, the first user device sets the LBT_COUNTER associated to resource set x to 0.

In an embodiment, the sidelink resource set may be one of: a sidelink resource pool, a sidelink resource block, an RB set, a sidelink channel, an LBT band, or a sidelink bandwidth part, BWP.

### Embodiment 2

### Unavailable Resource Set

In an embodiment, a method may comprise determining, with the first user device, a certain sidelink resource set to be an available sidelink resource set for the sidelink transmission in response to at least one of:
an expiration of a timer started in response to: an LBT failure indication from the LBT procedure or a sidelink consistent LBT failure triggered according to the LBT procedure;
a result of the LBT procedure being a success; or
a channel occupancy rate being lower than a first predetermined threshold.

In an embodiment, a method may comprise determining, with the first user device, a sidelink resource set to be an available sidelink resource set for the sidelink transmission in response to at least one of:
receiving any sidelink data or signaling from other user device in the sidelink resource set; or
a channel busy ratio being lower than a second predetermined threshold in the sidelink resource set; or
a RSSI being lower than a third predetermined threshold in the sidelink resource set.

In an embodiment, a method may comprise setting a sidelink resource set as an unavailable sidelink resource set, wherein the unavailable sidelink resource set comprises at least one of: a sidelink resource set on which the consistent LBT failure is detected, or a sidelink resource set for which the consistent LBT failure have been triggered.

In an embodiment, a method may comprise receiving, with the first user device, a timer value indicating when the timer expires or any of the predetermined thresholds mentioned above or hereafter from a wireless access node in response to the first user device being in coverage of the wireless access node.

In an embodiment, a method may comprise, in response to all configured normal sidelink resource sets being determined to be unavailable sidelink resource sets, using, with the first user device UE, the exception sidelink resource pool to perform a sidelink transmission.

### Embodiment 3

### After Detecting Consistent LBT Failure

In an embodiment, after the UE (e.g., the first user device or the first wireless communication terminal) detects the consistent LBT failure, it sends failure information to the peer UE (e.g., the second user device or the second wireless communication terminal) through other resource sets, and indicates information of the resource set where the consistent LBT failure occurred. If only the ID is included in the information, the UE may inform the peer UE about the mapping relationship between the ID and the location of the resource set (e.g., resource pool) in advanced.

In an embodiment, a wireless communication method may comprise detecting, by a first wireless communication terminal, a consistent listen-before-talk, LBT, failure for a sidelink transmission in a first sidelink resource set; and transmitting, by a first wireless communication terminal to a second wireless communication terminal in a second sidelink resource set, consistent listen-before-talk, LBT, failure indication information indicating a consistent LBT failure for a sidelink communication.

In an embodiment, the second consistent LBT failure indication information is transmitted by at least one of: a sidelink LBT failure MAC CE, sidelink control information, SCI, or short control signaling.

In an embodiment, the second sidelink resource set is an available sidelink resource set.

In an embodiment, if all the normal sidelink resource sets are unavailable sidelink resource sets, the second sidelink resource set may be the exceptional sidelink resource set.

In an embodiment, the consistent LBT failure indication information may include a sidelink resource set identity or identifier which may indicate the identity or identifier of the sidelink resource set where the consistent LBT failure occurs.

In an embodiment, a method may comprise, before transmitting, by a first wireless communication terminal to a second wireless communication terminal, the consistent LBT failure indication information, transmitting, by a first wireless communication terminal to a second wireless communication terminal, sidelink resource set configuration information which may include a mapping relationship between the sidelink resource set identity or identifier and the frequency resource location information.

In an embodiment, in response to determining the sidelink consistent LBT failure according to the LBT procedure, the first user device may send a sidelink LBT failure MAC control element (CE) to the wireless communication node. Then, the wireless communication node may allocate another sidelink resource set to the first user device. However, before that, the UE may need to continue to use current sidelink resource set. In an embodiment, in order to avoid releasing the PC5-RRC connection for the destination, when the first user device detects a sidelink consistent LBT failure in a sidelink resource set, it may suspend the sidelink Consecutive DTX counter(s) (numConsecutiveDTX) or suspend the RRC reconfiguration related timer(s) (T400) for one or more destination IDs associated to the sidelink resource set.

In an embodiment, after that, the first user device may cancel suspending the sidelink Consecutive DTX counter(s) (numConsecutiveDTX) or cancel suspending RRC reconfiguration related timer(s) (T400) for one or more destination IDs associated to the sidelink resource set that becomes an available sidelink resource set.

In an embodiment, the first user device may suspend the sidelink Consecutive DTXs counter (numConsecutiveDTX) or suspend RRC reconfiguration related timers (T400) for one or more destination IDs associated to the sidelink resource set in response to at least one of:
detecting a LBT failure,
a channel busy ratio being higher than a second predetermined threshold in the sidelink resource set;
an RSSI being higher than a third predetermined threshold in the sidelink resource set; or
a LBT failure rate on the first sidelink resource set being higher than a fourth predetermined threshold (e.g., in a certain period).

In an embodiment, the first user device may cancel suspending the sidelink Consecutive DTX counter(s) (numConsecutiveDTX) or suspending RRC reconfiguration related timer(s) (T400) for one or more destination IDs associated to the sidelink resource set in response to at least one of:
receiving any sidelink data or signaling from other user device in the sidelink resource set;
a channel busy ratio being lower than a second predetermined threshold in the sidelink resource set;
a RSSI being lower than a third predetermined threshold in the sidelink resource set;
a LBT success; or
a LBT failure rate on the first sidelink resource set being lower than a fourth predetermined threshold (e.g., in a certain period).

### Embodiment 4

Receiving Consistent LBT Failure Indication from Other UE

In an embodiment, for a sidelink communication, considering that a TX (transmission) UE (UE1) and a RX (receiving) UE (UE2) are in different locations and may be interfered by different devices, in some cases, even if a consistent LBT failure is triggered in the RX UE, the TX UE may not detect the LBT failure, so the LBT failure detection in the TX UE side does not mean the LBT failure in the RX UE side. Therefore, in order to know whether a consistent LBT failure is really triggered by the RX UE, one way is that the RX UE can indicate the SL-specific consistent LBT failure to the TX UE. As described above, if there are other available SL resource pool or SL RB set, the RX UE may switch to other available SL resource pool or SL RB set to perform sidelink transmission in case of consistent LBT failure triggered in current SL resource pool or SL RB set. Then, the RX UE can send the SL-specific consistent LBT failure indication to the TX UE via the new available SL resource pool or SL RB set. For this case, since TX UE does not detect consistent LBT failure but the RX UE detects consistent LBT failure, it results the TX UE keeps performing sidelink transmission in the sidelink resource pool or RB set in which consistent LBT failure is detected by the RX UE, the TX UE may not receive any HARQ feedback before the associated SL resource pool or SL RB set of RX UE become available again. In order to solve this issue, the TX UE can consider to change sidelink resource set to perform sidelink transmission.

In an embodiment, if a consistent LBT failure indication is received from UE2 (e.g., the first user device or the first wireless communication terminal as described above), the UE1 (e.g., the second user device or the second wireless communication terminal as described above) may send the consistent LBT failure indication received from UE2 to the base station (e.g., a gNB).

In an embodiment, the destination identity and consistent LBT failure indication received from UE2 may be included in the SidelinkUEinformationNR message.

In an embodiment, an sl-Failure may be set as consistent LBT failure for the associated destination in the SL-Failure information element included in the SidelinkUEinformationNR message.

In an embodiment, the UE1 may send the consistent LBT failure indication received from UE2 to the base station, the consistent LBT failure indication including the sidelink resource set indication.

In an embodiment, the resource set indication may be used to indicate one or more channel indication(s).

In an embodiment, a channel may refer to a carrier or a part of a carrier consisting of a contiguous set of resource blocks (RBs) on which a channel access procedure is performed in shared spectrum.

In an embodiment, the resource set indication may be used to indicate one or more sets of resource blocks or one or more resource pools.

In an embodiment, the sidelink resource set indication comprises at least one of: a non-preferred sidelink resource set, a preferred sidelink resource set, an available sidelink resource set or an unavailable sidelink resource set. Then, the network (e.g., the gNB) can take these information into consideration when allocating sidelink resource to the UE.

In an embodiment, if consistent LBT failure indication is received from UE2, and the UE1 is configured to perform sidelink resource allocation mode 2, the UE1 may consider the pools of resources indicated in the received consistent LBT failure indication message as unavailable pools of resources, or move the pools of resources indicated in the received consistent LBT failure indication message from the candidate pools of resources.

Afterward, the UE1 may select any pool of resources among the candidate or available pools of resources.

In an embodiment, the UE1 may consider the channels or RB sets indicated in the received consistent LBT failure indication message as unavailable channels or RB sets, or move the pools of resources indicated in the received consistent LBT failure indication message from the candidate channels or RB sets.

Afterward, the MAC entity of UE1 may indicate to the physical layer the unavailable or non-preferred channels or RB sets in the destination UE(s), so that the physical layer may be able to avoid using the unavailable or non-preferred channels or RB sets.

In an embodiment, the UE1 may select the time and frequency resources for transmission from the resources indicated by the physical layer which are within the candidate or available channels or RB sets.

In an embodiment, a channel refers to a carrier or a part of a carrier consisting of a contiguous set of resource blocks (RBs) on which a channel access procedure is performed in shared spectrum.

### Embodiment 5

Receiving Consistent LBT Failure Indication from Another UE

In an embodiment, when a user device (e.g., the UE1 described above) receives a sidelink consistent LBT failure indication information for a destination ID, RLF (radio link failure) due to HARQ DTX may be handled as follows.

In an embodiment, when the first user device wants to communicate with the second user device via unicast mode, the first and second user devices may first establish a PC5-RRC connection (also called a PC5 link) with each other. Since a user device may communicate with multiple user devices, such as for different types of services, then a user device may establish multiple PC5-RRC connections with the multiple user devices. The user device may use a destination ID to uniquely identify a PC5-RRC connection it establishes with another user device. Upon the first and second user devices establishing a PC5-RRC connection, they can exchange various information, including UE capability information, RRC configuration messages including measuring configuration information, or bearer configuration information, as non-limiting examples.

Additionally, the first user device may detect a radio link failure (RLF) for a PC5-RRC connection it established with the second user device. Upon detection of a RLF, the first user device may release the PC5-RRC connection, which may include releasing DRBs for the PC5-RRC connection and/or discarding NR sidelink communication configuration information for the PC5-RRC connection.

In an embodiment, the first user device may determine a RLF for a PC5-RRC connection in response to detecting that the number of consecutive hybrid automatic repeat request (HARQ) discontinuous transmissions (DTXs) has reached a maximum number of consecutive HARQ DTXs (sl-maxNumConsecutiveDTX). In general, a user device may detect a number of consecutive resources configured with a physical sidelink feedback channel (PSFCH) that do not receive a HARQ feedback message. The first user device may keep track of a current number of consecutive DTXs (numConsecutiveDTX). If the current number reaches or exceeds the maximum number, then the first user device may detect an RLF. Accordingly, in various embodiments, the first user device may determine if a PSFCH reception is absent on a PSFCH reception occasion. If so, then the first user device may increment the current count (numConsecutiveDTX) by one. The first user device may then compare whether the current count as reached the maximum number. If so, then the first user device may detect a RLF (also called a HARQ-based sidelink RLF) for the PC5-RRC connection. Additionally, for at least some embodiments, the MAC layer keeps track of the current count, and determines whether a RLF has occurred by comparing the current count with the maximum number. If the MAC layer detects an RLF, the MAC layer may notify the RRC layer.

In some situations where the first and second user devices communicate on an unlicensed carrier, if the second user device performs an LBT procedure and the result is a LBT failure, then the second user device may be unable to send HARQ feedback to the first user device. In situations where the first and second user devices communicate on a licensed carrier, consecutive HARQ DTXs most often occur due to the first and second user devices moving away from each other. For situations where the first and second user devices communicate on an unlicensed carrier, consecutive HARQ DTXs may occur due to the first and second user devices moving away from each other, and also because it is easier to reach the maximum number of consecutive HARQ DTXs for a specific destination. However, if the maximum number of consecutive HARQ DTXs is due to consistent LBT failure, the user device may not want to release the PC5-RRC connection for the destination.

In an embodiment, the first user device may be configured with a maximum number of consecutive HARQ DTXs in order to detect RLFs. In some embodiments, the first user device may receive the maximum number of consecutive HARQ DTXs from the wireless access node 104. In an embodiment, the first user device may be preconfigured with the maximum number of consecutive HARQ DTXs. In an embodiment, the first user device may maintain a count (numConsecutiveDTX), and the first user device may increment the current count (numConsecutiveDTX) by one if first user device determines that a PSFCH reception is absent on a PSFCH reception occasion. In an embodiment, if the first user device receives a sidelink consistent LBT failure indication information that indicates the sidelink consistent LBT failure from a second UE, first user device may determine that consecutive HARQ DTXs are due to consistent LBT failure not due to second user devices moving away. In an embodiment, in order to avoid releasing the PC5-RRC connection for the destination, when the first user device receive a sidelink consistent LBT failure indication information that indicates the sidelink consistent LBT failure from a second UE, it may suspend the sidelink Consecutive DTXs counter (numConsecutiveDTX).

In an embodiment, in response to at least one of the first user device receiving any data in the associated sidelink resource set, or the first user device receiving any data from the second UE; or the first user device determining the associated sidelink resource set becomes available, the first user device may cancel suspending the sidelink Consecutive DTXs counter (numConsecutiveDTX).

### Embodiment 6

### Receiving LBT Failure Indication

In an embodiment, when a user device receives a sidelink consistent LBT failure indication information for a destination id, RLF due to timer expiry may be handled as follows.

In an embodiment, a first user may detect a RLF for a PC5-RRC connection between the first and second user devices. The first user device may determine to perform a sidelink RRC reconfiguration procedure. Correspondingly, the first user device may transmit a sidelink RRC reconfiguration message to the second user device. After sending the RRC reconfiguration sidelink message, the first user device may also start a timer Tx (e.g., timer T400 or another timer) for the associate destination id. The first user device may stop the timer Tx for the associate destination id if the first user device receives a sidelink RRC reconfiguration completed message or a sidelink RRC reconfiguration failure message from the second user device before the timer expires.

In an embodiment, if the timer Tx is expired for a specific destination, the first user devices may consider sidelink radio link failure to be detected for this destination.

However, according to an embodiment, if the sidelink consistent LBT failure happens for a second user, it may not send a sidelink RRC reconfiguration completed message or a sidelink RRC reconfiguration failure message. Rather, it may send sidelink consistent LBT failure indication. In an embodiment, when the first user device receives sidelink consistent LBT failure indication from the second user devices, it may suspend a timer Tx (e.g., timer T400 or other timer) for the associate destination id. Thereby, the first user device may avoid releasing the PC5-RRC connection for the destination not moving away.

In an embodiment, in response to at least one of the first user device receiving any data in the associated sidelink resource set; or the first user device receiving any data from the second UE; or the first user device determining the associated sidelink resource set becomes available the first user device may cancel suspending the timer Tx (e.g., timer T400 or other timer) for the associate destination ID.

### Embodiment 7

In an embodiment, a first user device may detect a RLF for a PC5-RRC connection between the first and second user devices upon receiving indication from the sidelink RLC entity that the maximum number of retransmissions for a specific destination has been reached. The RETX_COUNT is a counter used to counter the number of retransmissions in RLC entity.

If the sidelink consistent LBT failure happens for a second user device, the first user device can suspend the RLC SDU (service data unit) for retransmission; or suspend the RETX_COUNT. Then, the first user device may not detect a RLF since the maximum number of retransmissions for a specific destination will not been reached if RLC SDU for retransmission or RETX_COUNT is suspending.

In another embodiment, if the sidelink consistent LBT failure is detected by the first user device, the first user device can suspend the RLC SDU for retransmission; or suspend the RETX_COUNT.

In an embodiment, in response to at least one of the first user device receiving any data in the associated sidelink resource set; or the first user device receiving any data from the second user device; or the first user device determining the associated sidelink resource set becomes available, the first user device may cancel the suspension of the RLC SDU for retransmission or the RETX_COUNT in the RLC entity for the associate destination ID.

### Embodiment 8

### LBT Failures on PUCCH and MAC CE

In an embodiment, if the sl-PUCCH-Config is configured by RRC signaling for a UE, the MAC entity may, for a PUCCH transmission occasion, determines if the most recent transmission of the MAC PDU is performed and if LBT failure indication is received from lower layers. If so, the MAC entity may instruct the physical layer to signal a negative acknowledgement on the PUCCH. It means that the sidelink transmission is not really performed due to the LBT failure, so the UE can send a negative acknowledgement on the PUCCH to the network. Then, the network may allocate another sidelink resource for the retransmission to the UE.

### CSI Reporting

In some embodiments, the Sidelink Channel State Information (SL-CSI) reporting procedure is used to provide a peer UE with sidelink channel state information.

RRC signaling configures the following parameters to control the SL-CSI reporting procedure:
sl-LatencyBoundCSI-Report, which is maintained for each PC5-RRC connection.

The MAC entity maintains an sl-CSI-ReportTimer for each pair of the Source Layer-2 ID and the Destination Layer-2 ID corresponding to a PC5-RRC connection. The sl-CSI-ReportTimer is used for an SL-CSI reporting UE to follow the latency requirement signaled from a CSI triggering UE. The value of the sl-CSI-ReportTimer is the same as the latency requirement of the SL-CSI reporting in the sl-LatencyBoundCSI-Report configured by an RRC.

For each pair of the Source Layer-2 ID and the Destination Layer-2 ID corresponding to a PC5-RRC connection which has been established by upper layers, the MAC entity may determine whether the SL-CSI reporting has been triggered by an SCI and not cancelled and whether the sl-CSI-ReportTimer for the triggered SL-CSI reporting expires.

If the SL-CSI reporting has been triggered by an SCI and not cancelled and the sl-CSI-ReportTimer for the triggered SL-CSI reporting does not expires, the MAC entity may determine whether the MAC entity has SL resources allocated for new transmission and the SL-SCH resources can accommodate the SL-CSI reporting MAC CE and its subheader as a result of logical channel prioritization. If so, the MAC entity may further determine if a Sidelink CSI Reporting MAC CE is sent and if an LBT failure indication is not received from lower layers. If so, the MAC entity may stop the sl-CSI-ReportTimer for the triggered SL-CSI reporting and cancel the triggered SL-CSI reporting. On the contrary, if the Sidelink CSI Reporting MAC CE is not sent or if the LBT failure indication is received from lower layers, the MAC entity may not stop the sl-CSI-ReportTimer for the triggered SL-CSI reporting and not cancel the triggered SL-CSI reporting.

In some embodiments, the MAC entity configured with Sidelink resource allocation mode 1 may trigger a Scheduling Request if transmission of a pending SL-CSI reporting with the sidelink grant(s) cannot fulfil the latency requirement associated to the SL-CSI reporting.

In some embodiments, RRC signaling may configure the following parameter to control the SL-IUC Information reporting procedure:
sl-LatencyBoundIUC-Report, which is maintained for each PC5-RRC connection.

In some embodiments, the MAC entity maintains an sl-IUC-ReportTimer for each pair of the Source Layer-2 ID and the Destination Layer-2 ID corresponding to a PC5-RRC connection. The sl-IUC-ReportTimer is used for an SL-IUC Information reporting UE to follow the latency requirement signaled from an IUC-Information triggering UE. The value of the sl-IUC-ReportTimer is the same as the latency requirement of the SL-IUC Information in the sl-LatencyBoundIUC-Report configured by RRC.

For each pair of the Source Layer-2 ID and the Destination Layer-2 ID corresponding to a PC5-RRC connection which has been established by upper layers, the MAC entity may determine if the SL-IUC Information reporting has been triggered by an SL-IUC Request MAC CE (and/or an SCI) and not cancelled. If so, the MAC entity may further determine if the sl-IUC-ReportTimer for the triggered SL-IUC Information reporting is not running or if the sl-IUC-ReportTimer for the triggered SL-IUC Information reporting expires.

If the sl-IUC-ReportTimer for the triggered SL-IUC Information reporting is running and if the sl-IUC-ReportTimer for the triggered SL-IUC Information reporting does not expire, the MAC entity may further determine if the MAC entity has SL resources allocated for new transmission and the SL-SCH resources can accommodate the SL-IUC Information MAC CE and its subheader as a result of logical channel prioritization. If so, the MAC entity may further determine if the Sidelink IUC MAC CE is transmitted and the LBT failure indication is not received from lower layers. If so, the MAC entity may stop the sl-IUC-ReportTimer for the triggered SL-IUC reporting and cancel the triggered SL-IUC reporting. On the contrary, if the Sidelink IUC Reporting MAC CE is not sent or if the LBT failure indication is received from lower layers, the MAC entity may not stop the sl-IUC-ReportTimer for the triggered SL-IUC reporting and not cancel the triggered SL-IUC reporting.

In some embodiments of the present disclosure, the consistent sidelink LBT failure may be detected for each sidelink resource set, and the sidelink resource set can be one of: sidelink resource pool, a sidelink resource block, RB set, a sidelink channel, an LBT band, or a sidelink bandwidth part, BWP.

In some embodiments of the present disclosure, it is described how to determine an unavailable sidelink resource set to be an available sidelink resource set, and when to use exceptional sidelink resource pool.

In some embodiments of the present disclosure, when the UE detects a consistent LBT failure in the first resource set, it may send the consistent LBT failure information in a second resource set to the peer UE, and the consistent LBT failure information includes the resource set information. If only a resource set ID is included, the UE may send a mapping relationship between the resource set ID and the resource location (e.g., information of time and/or frequency location).

In some embodiments of the present disclosure, it is determined when to suspend and cancel the suspension of the DTX counter or T400.

In some embodiments of the present disclosure, after receiving a consistent LBT failure indication from a first UE, a second UE may report the consistent LBT failure indication to the base station; The second UE may consider setting the associated sidelink RB or resource pool to be unavailable; perform a resource reselection; and/or suspend the DTX counter or.

In some embodiments of the present disclosure, operations for LBT failure on PUCCH and MAC CE are also provided.

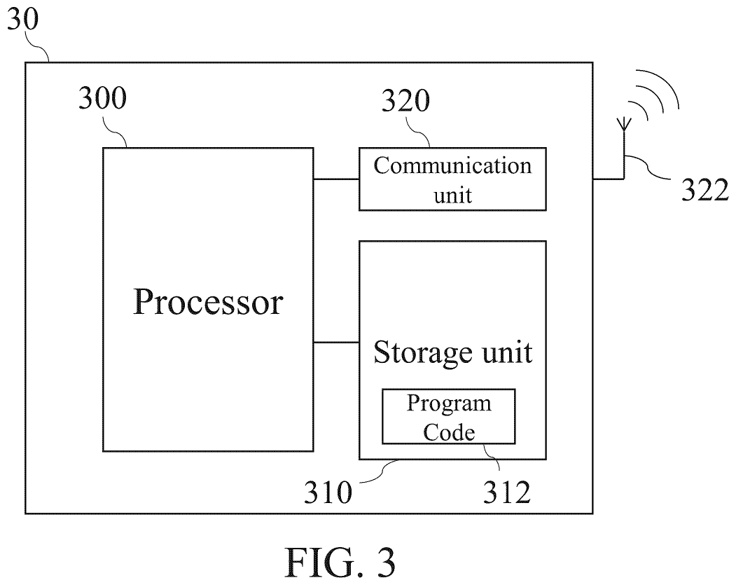

FIG. 3 relates to a schematic diagram of a wireless terminal 30 according to an embodiment of the present disclosure. The wireless terminal 30 may be a user equipment (UE), a mobile phone, a laptop, a tablet computer, an electronic book or a portable computer system and is not limited herein. The wireless terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage unit 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322 shown in FIG. 3.

In an embodiment, the storage unit 310 and the program code 312 may be omitted and the processor 300 may include a storage unit with stored program code.

The processor 300 may implement any one of the steps in exemplified embodiments on the wireless terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless network node (e.g., a base station).

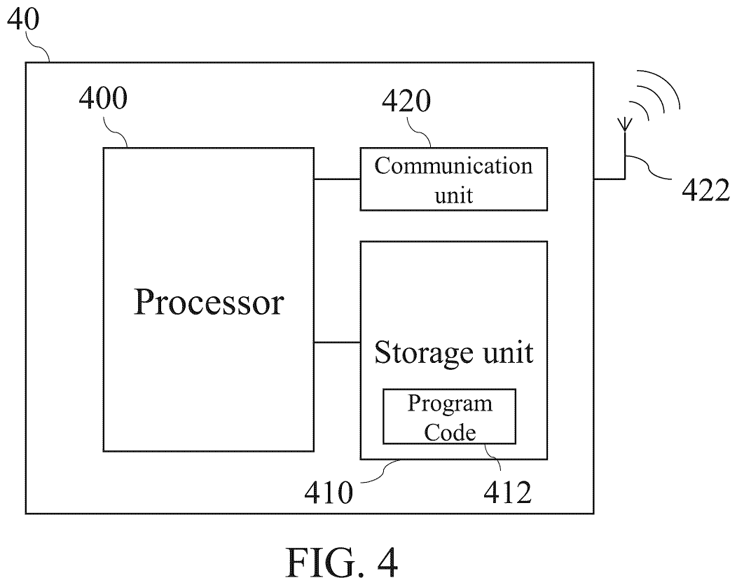

FIG. 4 relates to a schematic diagram of a wireless network node 40 according to an embodiment of the present disclosure. The wireless network node 40 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 40 may comprise (perform) at least one network function such as an access and mobility management function (AMF), a session management function (SMF), a user place function (UPF), a policy control function (PCF), an application function (AF), etc. The wireless network node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422 shown in FIG. 4.

In an embodiment, the storage unit 410 and the program code 412 may be omitted. The processor 400 may include a storage unit with stored program code.

The processor 400 may implement any steps described in exemplified embodiments on the wireless network node 40, e.g., via executing the program code 412.

The communication unit 420 may be a transceiver. The communication unit 420 may as an alternative or in addition be combining a transmitting unit and a receiving unit configured to transmit and to receive, respectively, signals to and from a wireless terminal (e.g., a user equipment or another wireless network node).

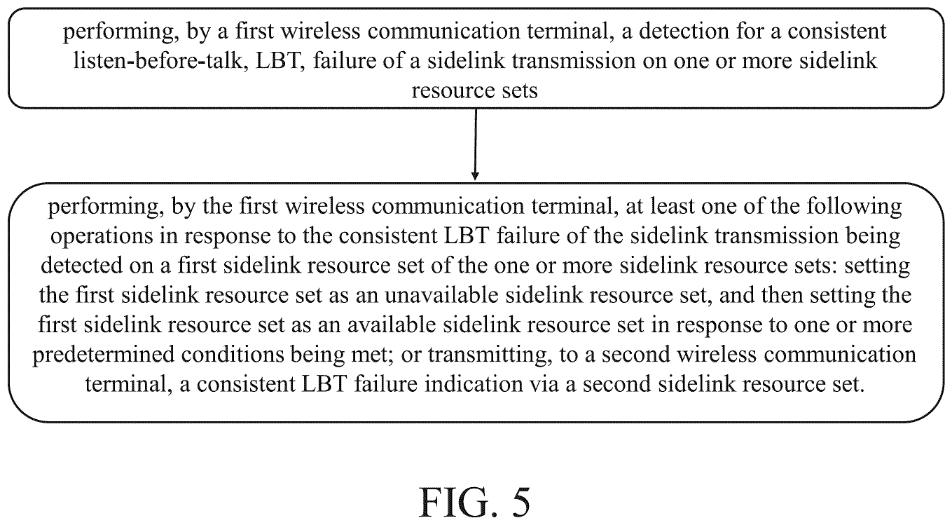

FIGS. 5 to 8 show flowcharts of wireless communication methods according to some embodiments of the present disclosure.

As illustrated in FIG. 5, in an embodiment, a wireless communication method includes: performing, by a first wireless communication terminal, a detection for a consistent listen-before-talk, LBT, failure of a sidelink transmission on one or more sidelink resource sets; and performing, by the first wireless communication terminal, at least one of the following operations in response to the consistent LBT failure of the sidelink transmission being detected on a first sidelink resource set of the one or more sidelink resource sets: setting the first sidelink resource set as an unavailable sidelink resource set, and then setting the first sidelink resource set as an available sidelink resource set in response to one or more predetermined conditions being met; or transmitting, to a second wireless communication terminal, a consistent LBT failure indication via a second sidelink resource set.

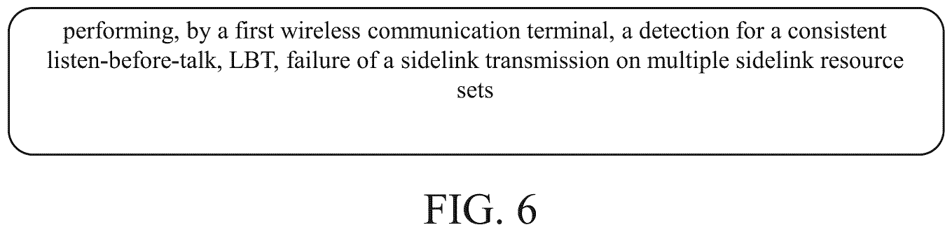

As illustrated in FIG. 6, in an embodiment, a wireless communication method includes: performing, by a first wireless communication terminal, a detection for a consistent listen-before-talk, LBT, failure of a sidelink transmission on multiple sidelink resource sets.

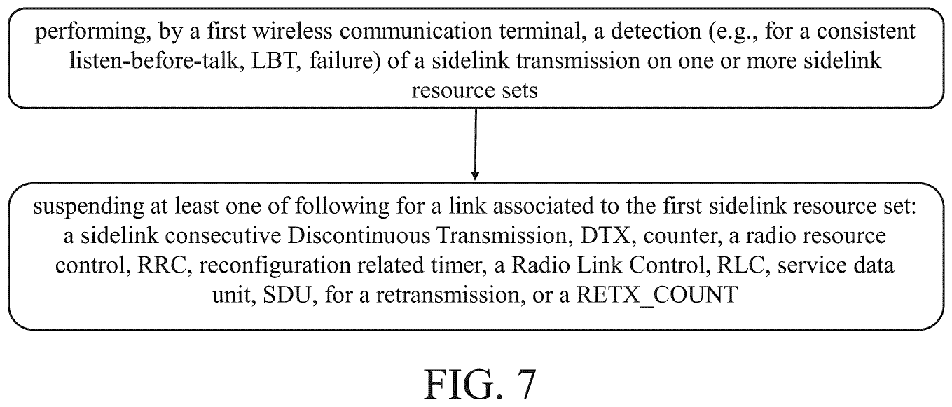

As illustrated in FIG. 7, in an embodiment, a wireless communication method includes: performing, by a first wireless communication terminal, a detection (e.g., for a consistent listen-before-talk, LBT, failure) of a sidelink transmission on one or more sidelink resource sets; and suspending at least one of following for a link associated to the first sidelink resource set: a sidelink consecutive Discontinuous Transmission, DTX, counter, a radio resource control, RRC, reconfiguration related timer, a Radio Link Control, RLC, service data unit, SDU, for a retransmission, or a RETX_COUNT.

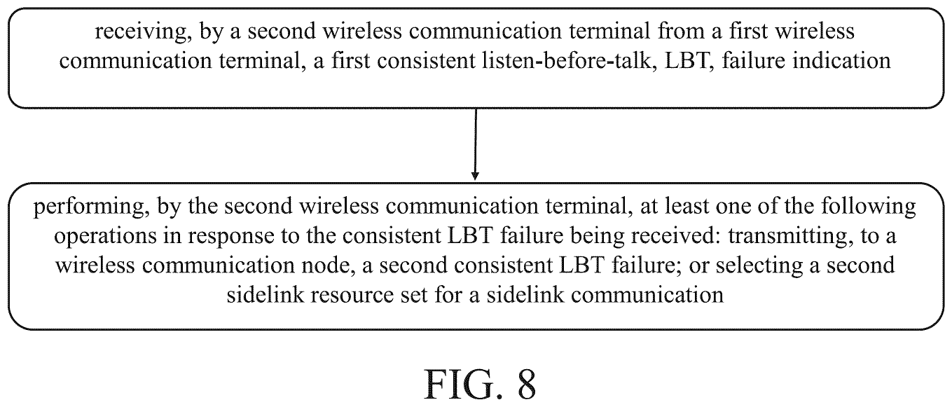

As illustrated in FIG. 8, in an embodiment, a wireless communication method includes: receiving, by a second wireless communication terminal from a first wireless communication terminal, a first consistent listen-before-talk, LBT, failure indication; and performing, by the second wireless communication terminal, at least one of the following operations in response to the consistent LBT failure being received: transmitting, to a wireless communication node, a second consistent LBT failure; or selecting a second sidelink resource set for a sidelink communication.

Details in this regard can be ascertained with reference to the paragraphs above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method comprising:
performing, by a first wireless communication terminal, a detection for a consistent listen-before-talk (LBT) failure of a sidelink transmission on one or more sidelink resource sets; and
performing, by the first wireless communication terminal, at least one of following operations in response to the consistent LBT failure of the sidelink transmission being detected on a first sidelink resource set of the one or more sidelink resource sets:
setting the first sidelink resource set as an unavailable sidelink resource set, and then
setting the first sidelink resource set as an available sidelink resource set in response to one or more predetermined conditions being met; or
transmitting, to a second wireless communication terminal, a consistent LBT failure indication via a second sidelink resource set.

2. The wireless communication method of claim 1, wherein the sidelink resource set comprises at least one of: a sidelink resource pool, a sidelink resource block (RB) set, a frequency resource range, or a sidelink bandwidth part (BWP).

3. The wireless communication method of claim 1, wherein the one or more predetermined conditions comprises at least one of:
an expiration of a timer started in response to an LBT failure indication from an LBT procedure on the first sidelink resource set or a sidelink consistent LBT failure triggered according to an LBT procedure on the first sidelink resource set;
a result of an LBT procedure on the first sidelink resource set being a success; or
a channel occupancy rate on the first sidelink resource set being lower than a first predetermined threshold,
wherein the first wireless communication terminal receives from a wireless communication node at least one of: a timer value for the timer, a value for the first predetermined threshold, a value for the second predetermined threshold, or a value for the third predetermined threshold.

4. The wireless communication method of claim 1, wherein the one or more predetermined conditions comprises at least one of:
the first wireless communication terminal receiving sidelink data or signaling from a user device in the first sidelink resource set;
a channel busy ratio being lower than a second predetermined threshold in the first sidelink resource set; or
a Received Signal Strength Indicator (RSSI) being lower than a third predetermined threshold in the first sidelink resource set,
wherein the first wireless communication terminal receives from a wireless communication node at least one of: a timer value for the timer, a value for the first predetermined threshold, a value for the second predetermined threshold, or a value for the third predetermined threshold.

5. The wireless communication method of claim 1, wherein the first wireless communication terminal performs the sidelink transmission via an exception sidelink resource set in response to all configured normal transmission sidelink resource sets are unavailable.

6. The wireless communication method of claim 1, wherein the consistent LBT failure indication comprises an identifier of the first sidelink resource set, or
wherein the first wireless communication terminal transmits sidelink resource set configuration information which includes frequency resources information associated to each identifier of sidelink resource set, or
wherein the first wireless communication terminal transmits to a second wireless communication terminal, a consistent LBT failure recovery indication in response to the first sidelink resource set becomes available.

7. The wireless communication method of claim 1, wherein the first wireless communication terminal suspends a sidelink consecutive Discontinuous Transmission (DTX) counter, a radio resource control (RRC) reconfiguration related timer, a Radio Link Control (RLC) service data unit (SDU) for a retransmission, or a RETX_COUNT for a link associated to the first sidelink resource set, and
wherein the sidelink consecutive DTX counter, the RRC reconfiguration related timer, the RLC SDU for the retransmission or the RETX_COUNT is suspended in response to at least one of:
an LBT failure on the first sidelink resource set being detected;
a channel busy ratio being higher than a second predetermined threshold in the first sidelink resource set;
an RSSI being higher than a third predetermined threshold in the first sidelink resource set; or
a LBT failure rate on the first sidelink resource set being higher than a fourth predetermined threshold.

8. The wireless communication method of claim 7, wherein a suspension of the sidelink consecutive DTX counter, the RRC reconfiguration related timer, the RLC SDU for the retransmission or the RETX_COUNT is canceled in response to at least one of:
the first wireless communication terminal receiving sidelink data or signaling from a user device in the first sidelink resource set;
a channel busy ratio being lower than a second predetermined threshold in the first sidelink resource set;
an RSSI being lower than a third predetermined threshold in the first sidelink resource set;
a result of an LBT procedure on the first sidelink resource set being a success;
a LBT failure rate on the first sidelink resource set being lower than a fourth predetermined threshold; or
the first sidelink resource set that becomes an available sidelink resource set.

9. The wireless communication method of claim 1, wherein the first wireless communication terminal performs at least one of following operations:
instructing, via a Medium Access Control (MAC) layer module, a physical layer module to signal a negative acknowledgement on a physical uplink control channel (PUCCH) to a wireless communication node in response to a transmission of a MAC Protocol Data Unit (PDU) being performed and an LBT failure indication being received from the physical layer module;
stopping an sl-CSI-ReportTimer for a triggered sidelink channel status information (SL-CSI) reporting in response to a Sidelink CSI Reporting Medium Access Control Control Element (MAC CE) being sent and an LBT failure indication not being received from the physical layer module;
canceling a triggered SL-CSI reporting in response to a Sidelink CSI Reporting MAC CE being sent and an LBT failure indication being not received from the physical layer module;
stopping an sl-IUC-ReportTimer for a triggered sidelink inter-UE coordination (SL-IUC) Information reporting in response to a Sidelink IUC MAC CE being sent and an LBT failure indication being not received from the physical layer module; or
canceling a triggered SL-IUC reporting in response to a Sidelink IUC MAC CE being sent and an LBT failure indication being not received from the physical layer module.

10. A wireless communication method comprising:
performing, by a first wireless communication terminal, a detection for a sidelink transmission on one or more sidelink resource sets; and
suspending at least one of following for a link associated to the first sidelink resource set: a sidelink consecutive Discontinuous Transmission (DTX) counter, a radio resource control (RRC) reconfiguration related timer, a Radio Link Control (RLC) service data unit (SDU) for a retransmission, or a RETX_COUNT.

11. The wireless communication method of claim 10, wherein the at least one of the sidelink consecutive DTX counter, the RRC reconfiguration related timer, the RLC SDU for the retransmission, or the RETX_COUNT is suspended in response to at least one of:
an LBT failure on the first sidelink resource set being detected;
a channel busy ratio being higher than a second predetermined threshold in the first sidelink resource set;
an RSSI being higher than a third predetermined threshold in the first sidelink resource set; or
a LBT failure rate on the first sidelink resource set being higher than a fourth predetermined threshold.

12. The wireless communication method of claim 10, wherein a suspension of the at least one of the sidelink consecutive DTX counter, the RRC reconfiguration related timer, the RLC SDU for the retransmission, or the RETX_COUNT is canceled in response to at least one of:
the first wireless communication terminal receiving sidelink data or signaling from a user device in the first sidelink resource set;
a channel busy ratio being lower than a second predetermined threshold in the first sidelink resource set;
an RSSI being lower than a third predetermined threshold in the first sidelink resource set;
a result of an LBT procedure on the first sidelink resource set being a success;
a LBT failure rate on the first sidelink resource set being lower than a fourth predetermined threshold; or
the first sidelink resource set that becomes an available sidelink resource set.

13. The wireless communication method of claim 10, wherein the first wireless communication terminal performs at least one of following operations:
instructing, via a Medium Access Control (MAC) layer module, a physical layer module to signal a negative acknowledgement on a physical uplink control channel (PUCCH) to a wireless communication node in response to a transmission of a MAC Protocol Data Unit (PDU) being performed and an LBT failure indication being received from the physical layer module;
stopping an sl-CSI-ReportTimer for a triggered sidelink channel status information (SL-CSI) reporting in response to a Sidelink CSI Reporting Medium Access Control Control Element (MAC CE) being sent and an LBT failure indication not being received from the physical layer module;
canceling a triggered SL-CSI reporting in response to a Sidelink CSI Reporting MAC CE being sent and an LBT failure indication being not received from the physical layer module;
stopping an sl-IUC-ReportTimer for a triggered sidelink inter-UE coordination (SL-IUC) Information reporting in response to a Sidelink IUC MAC CE being sent and an LBT failure indication being not received from the physical layer module; or
canceling a triggered SL-IUC reporting in response to a Sidelink IUC MAC CE being sent and an LBT failure indication being not received from the physical layer module.

14. A wireless communication method comprising:
receiving, by a second wireless communication terminal from a first wireless communication terminal, a first consistent listen-before-talk (LBT) failure indication; and
performing, by the second wireless communication terminal, at least one of following operations in response to the consistent LBT failure being received:
transmitting, to a wireless communication node, a second consistent LBT failure; or
selecting a second sidelink resource set for a sidelink communication.

15. The wireless communication method of claim 14, wherein the second consistent LBT failure indication comprises at least one of a sidelink resource set indication or a destination identity, and the destination identity indicates the first wireless communication terminal which detects the consistent LBT failure, and
wherein the sidelink resource set indication comprises at least one of: a non-preferred sidelink resource set, a preferred sidelink resource set, an available sidelink resource set or an unavailable sidelink resource set.

16. The wireless communication method of claim 14, wherein the second wireless communication terminal performs at least one of:
selecting a resource pool for the sidelink transmission among available resource pools, wherein the available resource pools exclude an unavailable resource pool indicated by the consistent LBT failure indication;
selecting time and frequency resources for the sidelink transmission among available channels or resource block (RB) sets, wherein the available channels or RB sets exclude an unavailable channel or RB set indicated by the consistent LBT failure indication; or
indicating, via a Medium Access Control (MAC) layer module to a physical layer module, an unavailable or non-preferred channel or RB set according to the consistent LBT failure indication.

17. The wireless communication method of claim 14, wherein the second wireless communication terminal suspends a sidelink consecutive Discontinuous Transmission (DTX) counter, a radio resource control (RRC) reconfiguration related timer, an RLC SDU for a retransmission or RETX_COUNT for a link associated to the first sidelink resource set in response to the consistent LBT failure indication being received, and
wherein a suspension of the sidelink consecutive DTX counter, the RRC reconfiguration related timer, the RLC SDU for the retransmission or the RETX_COUNT is canceled in response to at least one of:
the second wireless communication terminal receiving sidelink data or signaling from a user device in the first sidelink resource set;
the second wireless communication terminal receiving sidelink data or signaling from the first wireless communication terminal;
the second wireless communication terminal determining that the first sidelink resource set has become available;
the second wireless communication terminal receiving a consistent LBT failure recovery indication; or
the second wireless communication terminal determining to cancel the suspension of the sidelink consecutive DTX counter, the RRC reconfiguration related timer, the RLC SDU for the retransmission, or the RETX_COUNT.

18. A wireless communication terminal, comprising:
a communication unit; and
a processor configured to perform a wireless communication method of claim 1.

19. A wireless communication terminal, comprising:
a communication unit; and
a processor configured to perform a wireless communication method of claim 10.

20. A wireless communication terminal, comprising:
a communication unit; and
a processor configured to perform a wireless communication method of claim 14.
